(19) United States
(12) Patent Application Publication
(10) Pub. No.: US 2006/0015384 A1
(43) Pub. Date: Jan. 19, 2006

(54) Business management and procedures involving intelligent middleman

(76) Inventor: Donald O'Neill, Montgomery Village, MD (US)

Correspondence Address: John P. Halvonik, Ste. 202, 15200 Shady Grove Rd., Rockville, MD, 20840, US

(21) Appl. No.: 10/890,221

(22) Filed: Jul. 14, 2004

(51) Int. Cl. G06Q 99/00

(52) U.S. Cl. 705/8; 705/1

(57) ABSTRACT

A system of infrastructure and communications networks that will enable employees (“intelligent middlemen”) located in offshore areas to facilitate the exchange of economic assets and information among themselves. Such assets include: cultural, technical and legal rights and remedies, software engineering and various other business skills, from buyer to seller. There are two main types of control points involved in the system, at least one GECP operating in the U.S. and managing the network of global enterprises seeking to outsource software development and operations offshore. And at least one OVC, that operates in the target country and manages the network of outsource vendors.

### SUMMARY OF THE INVENTION

The invention relates to the field of management of a business and economical enterprise operation that is directed toward creating a communications system of infrastructure and communications networks that will enable employees (“intelligent middlemen”) located in offshore areas to facilitate the exchange of economic type assets and information among themselves. Such economic assets should include: cultural, technical and legal rights and remedies, software engineering and various other business skills, from buyer to seller.

Primarily, the system will manage a network of global enterprises seeking to outsource software development and operations offshore. There are two major types of control points, at least one GECP that operates in the U.S. and manages the network of global enterprises seeking to outsource software development and operations offshore. And at least one OVC, that operates in the target country and manages the network of outsource vendors

It is an object of the invention to provide a timely and efficient manner of managing data assets pertaining to economic development projects going on in several different nations at any given time.

Another object is to minimize the risks and maintain the benefits of an economic globally-based, enterprise that deals with software producers in off shore nations that would otherwise be barred by adverse risks associated with such global enterprises

Another object is to provide a method of bringing together vendors and purchasers of business skills and acumen through a management project utilizing human skills and acumen to be traded upon and information pertaining to these projects managed by an information exchange involving a trusted pipe connecting control points onshore and offshore.

Other objects of the invention will be apparent to those skilled in the art once the invention is shown and described.

### BRIEF DESCRIPTION OF THE DRAWINGS

FIG. 1 overlay of overall system and relationship of GECP to OVCP and various sections of the method;

FIG. 2 the Global Enterprise process shown an ETVX diagram;

FIG. 3 the Global Enterprise Control Point process shown an ETVX diagram;

FIG. 4 the Outsource Vendor Control Point process shown an ETVX diagram;

FIG. 5 the Outsource Vendor process shown an ETVX diagram.

### FIG. 5 ENCLOSED SEPARATELY

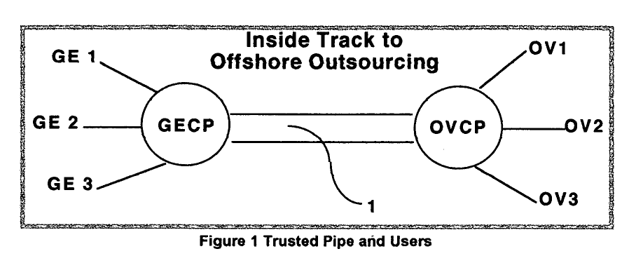

FIG. 1 Trusted Pipe and Users

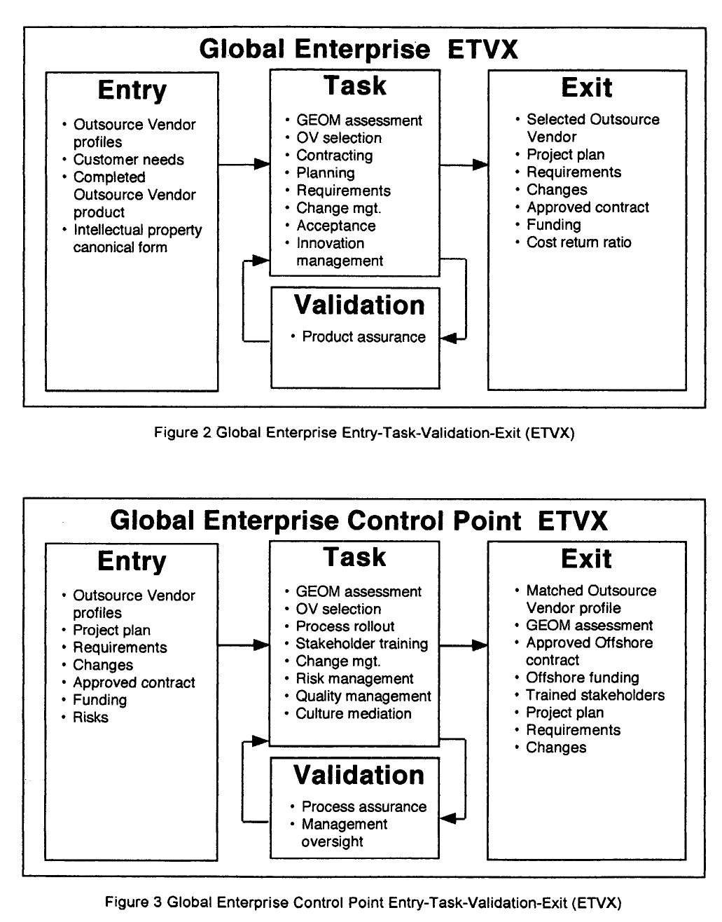

FIG. 2 Global Enterprise Entry Task Validation Exit (ETVA)

FIG. 3 Global Enterprise Control Point Entry Task Validation Exit (ETVX)

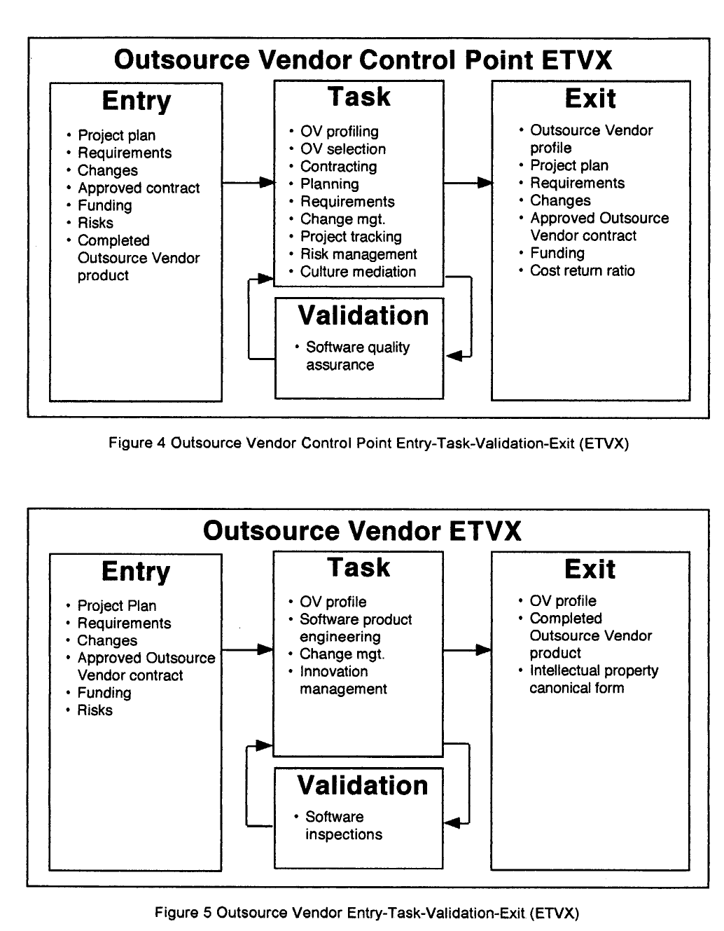

FIG. 4 Outsource Vendor Control Point Entry Tasks Validation Exit (EVTX)

FIG. 5 Outsource Vendor Entry Task Validation Exit (ETVX)

### DESCRIPTION OF THE PREFERRED EMBODIMENT

Information transmission that is relevant to the development process needs to travel in two way direction from each of two types of control points. 1) a Global Enterprise Control Point (GECP) that operates in the United States and manages the network of Global Enterprises seeking to outsource software development and operations offshore. 2) an Outsource Vendor Control Point (OVCP) that operates in the target country and manages the network of outsource vendors.

This pipeline or trusted pipe, is composed of a high seed, secure electronic network (1) and the connecting control point nodes labeled GECP and OVCP in FIG. 1, the Trusted Pipe and Users. The GECP operates in the U.S. and manages the network of global enterprise (GE) users of the trusted pipe seeking to initiate the target country and manages a network of Outsource Vendor (OV) users of the trusted pipe seeking to fulfill outsource software projects.

The infrastructure and associated lines of communication that pertain to the invention described here may be referred to as a “a trusted pipe” in order to convey the concept of a secure line of information as well a flow of information pertaining to several different subjects. The infrastructure consists primarily in the form of high speed, secure communications lines such as fiber optics, telephone lines, fax, etc. and associated hardware to control these and to maintain assets, such as human resource personnel and computer data bases that operate in conjunction with the communications lines. Such hardware associated with the network and the people who operate it will reside in at least two control points one of them being the GEPC and one of them being the OVC.

The transmission of information relevant to the project needs to be on a two way basis among these two points. Such information will pertain to many issues including: hard and soft skills including ethical issues; cultural mediation issues; intellectual property rights and legal opinions; security and privacy safeguards; technology, management and engineering practices, knowledge, and skills; domain knowledge; and technology infrastructure.

The GECP manages the network of global enterprises seeking to outsource software development and operations offshore. The OVCP operates in the target country and manages the network of outsource vendors. At the time of writing, such preferred target countries would likely be Russian, India and China although selection of such countries may be varied in accordance with project needs and changing economic conditions.

Those nations currently thought to be useful in this process would likely be those countries that have a competitive wage structure and an educated work force. Access to the world's high skilled, low cost software providers (typically in the target country) may be barred by adverse risks associated with global enterprises. The communications network and associated hardware and infrastructure described herein are designed in order to overcome most or all of these problems and risks.

The virtual network or “trusted pipeline” should provide for a multi-dimensional channel capable of rapidly exchanging essential management, engineering, process, business, legal, and cultural messages in a predictable and reliable manner among the two control points. The intended purpose of these multi-dimensional messages is to facilitate a coordinated interaction between those personnel running the Global Enterprise and those personnel who are managing and working at the Outsource Vendor. The communications flow of multi dimensional messages along the pipeline is organized along several different categories in order to avoid conflict, smooth out the impact of misunderstandings, and lessens the effects of any shortfalls and mismatches in expectation and delivery. It is the role of the Intelligent Middlemen to compose and interpret these multi-dimensional messages at each of the control points and hence, the need for well structured and organized messages.

It is believed that off shore nations such as Russia, India, and China would provide the best source of a trained work force for such a globally based software development operation but the invention is not wedded to work force in any one country. To summarize, it is thought that countries that would make a good target country should have a competitive wage structure and an educated work force.

As offshore development procedures move to smaller projects, it is believed that a dependable mechanism is needed to efficiently and effectively manage and initiate global enterprise computer program software projects, including the oversight of projects and their fulfillment by offshore vendors. Management oversight of the project would take place at the GECP and is shown as one part of the overall GECP process in FIG. 3. Quality control of the product as it is being produced would take place at the OVCP and is depicted as one of the tasks in FIG. 5.

The Trusted Pipe Architecture (TPA) features an in-country control point connected by high speed line, secure line to an out-country control point with capabilities and protocols organized into seven layers. These intelligent layers include both hard and soft skills spanning ethical dimensions, cultural mediation, intellectual property safeguards, security and privacy safeguards, management and engineering practice, domain knowledge, and technology infrastructure. The knowledge, skills, and behaviors for installing and operating the control points and for using the Trusted Pipe and interacting with a control point reside in an on the shelf training program for rolling out TPA. The candidate for a roll out may be a company or a country.

Many enterprises could be engaged in that would have the minimal sort of economic issues involving entities and having a need to know information from a network of enterprises with a need to initiate an offshore outsourcing computer program software project. Such enterprises would involve vendors with the capability to fulfill an offshore outsourcing computer program software project.

The intended purpose of these multi dimensional messages is to facilitate a coordinated interaction between the global enterprise and the outsourcing vendor. One that avoids conflict smooths out the impact of misunderstandings and dampens down reaction to shortfall and mismatch in expectation and delivery. It is the role of the intelligent middleman to compose and interpret these multi dimensional messages.

The pipeline shown in the figures signifies the two-way exchange of assets and information pertaining to the business project, for example. Multi channels of communications insure that many tasks and exchanges will be done in several categories or types of activities. Such activities include:

Issues and Benefits

The benefits of the process described herein derive from the ability of the mechanism to pro actively address the concerns of global enterprises associated with due diligence. These issues are the source of outsourcing resistance and span business and legal, cultural, technical and legal, and software engineering and management.

Business and Legal; includes such categories as:
Intellectual Property protection
Intellectual Property recapture
Commodity/Strategic balance
Corporate Anonymity, Privacy

Cultural; includes such categories as:
Shortfall and relationships
Multi-dimensional views
Mismatch in cultural style

Technical and Legal; includes such categories as:
Control of computer and network security
Control of piracy
Vetting of workers

Software Engineering and Management; includes such categories as:
Shift from capability maturity to product engineering
Process of experimentation facilitated
Cost, schedule, and quality control
Coordinating cost, billing, and change
Management, oversight, and governance
Seat in board room

Business and Legal

With the Trusted Pipe, the management and control of intellectual property is accomplished with increased confidence by spanning the boundary between legal and technical factors. The global enterprise is assured of recapturing intellectual property derived during the engagement. This is accomplished by employing a standard template to record processes, designs, and algorithms. These standard templates permit the Global Enterprise legal staff to fashion artifacts for use in the United States Patent and Trademark Office (USPTO) process of patents, copyrights, trademarks, and trade secrets. This aspect of the enterprise will facilitate outsourcing that can be can be shifted towards strategic content with greater confidence

Cultural

With the infrastucture and communications lines in place, this part of the system will be referred to as the “Trusted Pipe.” Such a pipe will that is well organized will preclude misunderstandings between workers and management as well as expectation shortfalls. The trusted pipe will be able to dampen such shortfall without damaging network relationships between global enterprises and outsource vendors. This will be done by operators, at each of the control points, who will be knowledgeable in the cultural differences between the parties. Issues can be handled in the best possible way by knowledgeable people who will be able to take into account many such issues including management, engineering, process, business, legal, and culture issues. Mismatches in cultural style between workers in one nation and managers in another nation, many miles away, can be anticipated and various conflicts reconciled through use of the trusted pipe system.

Technical and Legal Issues.

The computer and network security operations of the offshore vendor can be controlled by persons employed by the enterprise. Issues such as piracy of software and background checks of workers would be some of the issues handled by people in this department.

Software Engineering and Management.

In the enterprise described here the outsource vendor focus shifts from software process maturity to software product engineering. The OVCP shoulders the burden of software project management and quality assurance. The GECP performs oversight and governance and process management. The process of experimentation inherent in software development and essential for innovation is facilitated through a rapid, predictable, and reliable operation.

Costs, schedule, and quality will be managed and controlled by those managers communicating with one another at each of the control points. It is thought that the cost and billing model can be well coordinated with the change management mechanism in such a way as to diminish shortfall in expectation by spanning the boundary between management, engineering, and business factors. Software development activity will thus be accorded the best possible management, oversight, and governance.

Matching Global Enterprise and Outsource Vendor.

Like many businesses, software production and development depends heavily on matching the right buyers with the right sellers and buffering misunderstandings and maintaining the calibration of expectation and delivery. Finding the right matches is greatly assisted by assessing the global enterprise outsourcing maturity capability and profiling the leading indicators of the outsource vendor.

The GECP utilizes the Global Enterprise Outsource Maturity (GEOM) Assessment Instrument to identify findings and their consequences and formulate recommendations and plans for improvement. The global enterprise will understand how mature it is in seeking to achieve global software competitiveness, what it seeks to accomplish with offshore outsourcing, and what steps it must take to better position itself for success.

The OVCP utilizes the Outsource Vendor Profile (OVP) to characterize the vendor space. The leading indicators in the profile instrument may suggest avenues and directions for vendor improvement.

With a repository of Global Enterprise assessments and Outsource Vendor profiles it is possible to match buyers and sellers that promise a well managed operation. Maintaining a collection of these assessments and profiles yields a repository of valuable information that serves to authenticate and professionalize the broker, clearinghouse, and gatekeeper role envisioned by the process. This will assist in transitioning the business from the initial push to one of constant pull for the sustaining operation.

Global Enterprise Outsource Maturity (GEOM)

Global outsourcing is used to project the competitiveness of the enterprise. It is a defined process that operates as a disruptive technology in distinguishing an enterprise from its competition. Like any technology, user enablement transitions from novice to expert. Global Enterprise Outsourcing Maturity (GEOM) plots these transitions and pinpoints the capabilities that underlie them.

GEOM is intended for use by both the buyer and seller of outsourcing services as a means to calibrate buyer expectations and align seller capabilities. It provides criteria for source selection useful to buyers. It provides a benchmark for sellers to strive for. GEOM is composed of a maturity model, an assessment instrument, and a database of practicum.

GEOM is composed of five process elements:

1. Decision focuses on the Business Value Proposition and relies on Strategic/Commodity Offering and Seller Financials and Risk. Strategic/Commodity Offering distinguishes between software assets that are strategically essential and those that are simply commodities when selecting outsourcing candidates and determines the optimum life cycle scope for the outsourcing engagement. Business Value Proposition features a return on investment calculation that draws upon the Seller Financials and Risk process for in-house cost estimates and outsource cost estimates, risk identification, and termination cost estimate and factors in wage scale elasticity for both in-house and outsource operations.

2. Readiness ensures there is a focus on strategic software management and the software project suite practices needed both in-house and outsource as well as well developed managing and governance capabilities and software product engineering practices. Strategic Software Management includes shared vision among stakeholders, software engineering process, software project management, software product engineering, domain architecture, and operations support. Software Project Suite practices include: Planning, Tracking and Oversight, Requirements Determination, Software Product Engineering, Software Configuration Management, Risk Management, and Metrics. Managing & Governance capabilities include the Source Selection Process, Requirements Process, Configuration Management, and Governance and Oversight Process. It is recognized that Software Product Engineering practice may vary and may include Ad Hoc Programming, Structured Software Engineering, and Disciplined Software Engineering.

3. Culture spans specific issues relevant to that vendor including: national, legal and ethical issues, corporate, and process. National includes considerations, such as, language, work ethic, ethics, and militancy. Legal & Ethics spans issues including: Intellectual Property, Piracy, Security, Privacy, Trustworthy Software, and worker vetting. Corporate has do with commitment issues, management issues, product perfection, and/or personnel resources. Process is based on the Software Engineering Institute's Capability Maturity Model.

4. Competitiveness focuses on Supplier Control, Customer Control, Competitor Control, and Event Threat Control. Supplier Control includes establishing attractive workplace culture, achieving maturity in process and skills, fostering deep industry relationships within supplier community, and retaining personnel. Customer Control includes fostering deep customer relationships, balancing business factors, and achieving total customer satisfaction. Competitor Control includes fostering deep community relationships, fielding superior products, and leading niche direction Event Threat Control includes guarding against government intrusion, applying strategic software management, performing due diligence, and understanding reality.

5. Performance focuses on product quality level, span of control and frequency of release. Product Quality Level measured in defects per thousand lines spans 10-100/1000, 1-10/1000, 1-1/1000, and 0.01-0.1/1000. Span of Control measured in lines of code per individual spans under 12,500, 12,501-25,000, 25,001-50,000, 50,001-100,000, 100,001-200,000, and above 200,000. Frequency of Release spans daily, weekly, monthly, quarterly, semi-annually, and annually.

Outsource Vendor Profile

The Outsource Vendor Profile (OVP) assesses factors associated with initial conditions, infrastructure, and experience of the potential offshore vendor nation. These steps in the process are depicted in the right hand compartment of both FIGS. 4 and 5. Initial assessment factors here include: English language fluency among workers, low wage structure, financial literacy, worker compliance, and privacy and anonymity. Infrastructure factors include software education, software process maturity, access to technology cluster support, telecommunications, legal structure, mutuality in trade, and IP protection and recapture. Experience factors include product offering experience, service offering experience, package application skills, open source experience, and application domain skills.

Offshore Outsourcing Strategic Planning

For the global enterprise, offshore outsourcing is irresistible and once done, irreversible. In addition, the global enterprise will find that software operations cannot be harmoniously bifurcated, some projects may need to be in-house and others offshore. Software competence will land in one place or the other. Today there may be a hesitation to outsource on the part of some global enterprises due to the issues already discussed and due to inexperience in outsourcing.

The vision for the Inside Track to Offshore Outsourcing is to be the global clearinghouse and gatekeeper for software outsource knowledge, skills, behaviors, operations, and relationships. In short the Inside Track operates as the global Chief Knowledge Officer for offshore outsourcing.

Wrapping the offshore outsource operation into the larger context of global software competitiveness elevates the discussion adding additional value for the global enterprise network. Establishing a leadership position in global software competitiveness and providing the mechanism to assess the global enterprise serve to initiate a progressive deepening of relationships that enrich the context of outsourcing engagements and move them beyond commodity applications to more strategic products and services. With this global software competitiveness assessment in hand, the next step is to assess global enterprise offshore outsource maturity. At the same time, outsource vendor candidates are profiled providing the opportunity to initiate a progressive deepening of relationships on that side.

The market development strategy begins by kicking off a series of push events including selective and invited conference participation and complimentary seminars. With this in place, the effort is to evolve into pull tactics exploiting established global enterprise, country, and offshore vendor relationships and established community relationships.

With the mega-deal giving way to engagements that are smaller and more narrowly focused, there is an increase in the depth of knowledge needed to participate in the space including the management, engineering, and processes being outsourced; the precision in the drivers of the tipping point for the cost reduction benefit; and the quality of the relationships among global enterprises and outsource vendors.

Infrastructure Implementation

Managing the arrangement of global participants and value hierarchy is a maxima-minima problem of pushing the highest skill work to the lowest cost.

In the Inside Track, the highest value is assigned the legal and business functions of the Global Enterprise; the lowest value is assigned the engineering function of the Outsource Vendor. The Global Enterprise business need is met by the Outsource Vendor engineering solution. The process, management, and culture functions performed by the Global Enterprise and Outsource Vendor Control Points are necessary to eliminate friction. In the international outsourcing environment, this is what the outsourcing integrator does, i.e. it selects and organizes the parts and eliminates friction thereby improving the predictability of the outcome.

Quality Management System

Capability Maturity Models

Carnegie Mellon University's (CMU) Software Engineering Institute (SEI) evolved the Capability Maturity Model (CMM) for Software which is composed of key process areas of software capability. The Inside Track distributes the process areas of the Capability Maturity Model across the role players and places the largest burden of compliance on the control points (GECP and OVCP). The Global Enterprise buyer is expected to possess capability in software project planning, subcontract management, requirements determination and management, software configuration management, and peer reviews. Such tasks are depicted in FIG. 2 in the middle/upper compartment. The Outsource Vendor is expected to possess capability in software product engineering, peer reviews, and software configuration management. Such tasks are referred to in FIG. 4 the upper/middle compartment.

The Global Enterprise Control Point (GECP) and the Outsource Vendor Control Point (OVCP) are expected to possess the full range of capabilities in project management, product and engineering, and software process management.

ISO 9000

The International Standards Organization (ISO) evolved the ISO 9000 to stimulate and guide enterprise process improvement. The vision driving the quality policy of the Inside Track is to be the global clearinghouse and gatekeeper for software outsource knowledge, skills, behaviors, operations, and relationships. Specific quality objectives are organized around the mission to:
Establish global enterprise competitiveness leadership
Assess maturity of enterprise global software competitiveness
Assess global enterprise offshore outsource maturity
Profile outsource destinations both country and vendor
Process interactions and procedures are defined by the operations of the Trusted Pipe governing interactions among stakeholders.

Trusted Pipe Responsibilities

The resulting flow of information from GECP to OVCP will essentially package the knowledge, skills, and behaviors relevant to offshoring projects into a sustaining mechanism and reduces the burden on the Global Enterprise and Outsource Vendor.

Global Enterprise (GE). The Global Enterprise considering offshoring workload begins the process by conducting a Global Enterprise Outsource Maturity (GEOM) assessment spanning leading indicators associated with decision, readiness, culture, competitiveness, and performance expectations. This early step is shown at the top of the middle compartment in FIG. 2 and the positioning of this step in the chart reflects it's timing in relation to the other steps below it in the compartment.

Based on the assessment findings and the scope of outsource engagement envisioned, the Global Enterprise draws upon the Inside Track training product foundation and conducts training to position participants for the business, management, and engineering roles in off-shoring.

The Global Enterprise identifies the workload to be outsourced, matches its assessment and Outsource Vendor profiles in selecting candidate vendors, determines the requirements and plans the project, manages and controls changes to the requirements, performs necessary procedures to accept the product, and recaptures the intellectual property created during the engagement. These steps are briefly depicted in the middle section of the flow chart in FIG. 2 and are placed in an order that reflects their relative timing in the process, however many of these steps will be taking place simultaneously.

Experience obtained in the off-shoring engagement assists the Global Enterprise in earning a seat in the boardroom in order to guide the transition from commodity to strategic off-shoring content.

Global Enterprise Control Point (GECP). The Global Enterprise Control Point is the onshore engine for the Inside Track creating and refining the processes and conducting the training needed to standup the GECP itself and kickoff and standup the Outsource Vendor Control Point. See FIG. 3, the Global Enterprise Entry Task Validiation Exit (ETVX).

Some of the Outsource Vendor Profile Questions to include in the selection process are those listed below (the list is not exclusive, other questions may arise as well):

Are the management and technical staff fluent in English?

Is the management staff financially literate?

Are buyer anonymity and privacy assured?

Are workers vetted for professional capability and background?

Are modern telecommunications available?

Are network and computer security protected?

Are the management and technical staff CMM experienced?

Is software quality assurance practiced?

Is software project management practiced?

Is disciplined software engineering practiced?

Is intellectual property protected?

Is intellectual property created recaptured?

Rollout Steps

The control points and Trusted Pipe must be ready for prime time on day one. The steps leading to rollout include:

1. Create process and plan

2. Obtain GECP commitment

3. Standup GECP

4. Obtain OVCP commitment

5. Standup OVCP

6. Assess Global Enterprises

7. Profile Outsource Vendors

8. Initiate engagements

The GECP conducts GEOM assessment and rolls out the process to the Global Enterprise and Outsource Vendor. The global enterprise tasks and implementation scheme is shown in FIGS. 2 and 3 and is designed to ensure that diligent procedures are in place throughout the process. The global enterprise will perform process assurance. During the offshore operations of the project, the GECP will perform management oversight and risk management including the coordination of cost, billing, and changes. See FIG. 3, the Global Enterprise Control Point: Entry-Task-Validiation-Assessment ETVX.

Outsource Vendor Control Point (OVCP). The Outsource Vendor Control Point is the driving engine for the offshore operations including receiving the training needed to standup itself. The OVCP conducts OV profiles, rolls out the process to the Outsource Vendor, and installs the due diligence procedures. A brief overview of this process is shown in FIG. 4, the Outsource Vendor Control Point Entry Task Validation Exit (ETVX).

During the offshore engagement, the OVCP performs quality assurance and takes the lead in mediating cultural issues as well monitoring risk associated with cost, schedule, quality, and changes. See FIG. 4.

Outsource Vendor (OV) The Outsource Vendor begins the process by conducting an OV profile and the receiving the software product engineering training necessary to operate harmoniously within the Inside Track during an offshore engagement. See FIG. 5, the Outsource Vendor Entry Task Validation Exit (ETVX).

Rollout Training

The infrastructure implementation activity calls for the creation of processes and the preparation of policies, procedures, training events, and measurements associated with the business and legal, process, management and culture, and engineering functions. These steps in the process are briefly depicted as one of the tasks in the flow chart of FIG. 3.

The training for Global Enterprise, Global Enterprise Control Point, Outsource Vendor Control Point, and Outsource Vendor has been identified and spans:
Program Introduction
Competitiveness and Strategic Management
Participant Assessment and Profiling
Quality Management System
Project Management
Measurement
Disciplined Software Engineering
Management of Innovation
Bridging the Cultural Gap

### A HYPOTHETICAL EXAMPLE

Let's consider a software project. Done in the US a project takes 100% of effort, about 33% high value jobs and 67% low value jobs. When outsourced offshore, this software project takes 130% effort. The 33% of old high value jobs (business, legal, and program management functions) remains in the US. The 67% low value jobs (engineering) move offshore. The added 30% created by offshoring are medium value jobs evenly split between US (process functions) and offshore (software management and culture mediation). Important to note, US workload is full cost; offshore workload is one-sixth to one-third of US full cost.

As a result, the US performs 48% (33%+15%) of workload in high and medium value jobs. The offshore operation performs 82% (67%+15%) of workload in medium and low value jobs. Outsourcing delivers 11% cost savings at higher offshore rates to 22% cost savings at lower offshore rates. Outsourcing cost savings stimulate additional project initiation. If software project demand doubles, the number of US jobs will be restored to current levels, but these jobs will operate higher in the value chain.

What is claimed is:

1. A method for controlling the offshore outsourcing of a computer program software development project, the project including the steps of managing at least one activity selected from the following activities: specifications, design, code, test, and maintenance of the software codes; said method including: setting up a global enterprise communications system having at least one pair of communications network points, said communications network points comprising a Global Enterprise Control Point GECP and a Outsource Vendor Control Point OVCP, said OVCP located in an offshore nation; and said communications system having at least one desktop computer client being connected through an electronic network to a server located at said GECP, said GECP server being connected through at least one high speed dedicated secure line to an OVCP server, and said OVCP server being connected through an electronic network to at least one offshore vendor desktop computer client(s) wherein said GECP is connected by high speed secure line to an OVCP; and having trained middlemen personnel at said OVCP able to collect and interpret messages from said GECP;
Said method comprising the steps of:
a. inputting data associated with said software development project, said data taking the format of multi-dimensional messages having to do with the development project, said dimensions relating to management, engineering, process, business, legal, and cultural issues relating to said project;
b. presenting said multi dimensional messages in a manner understandable to the middleman;
c. transmitting multi-dimensional message(s) over said electronic network;
d. making decisions at said GECP in order to manage the electronic network of global enterprises seeking to initiate offshore outsourcing of computer program software projects;
e. making decisions by middlemen at the OVCP offshore so as to manage the electronic network of outsource vendors seeking to fulfill offshore outsourcing of computer program software projects;
f. performing at least one out-country outsource vendor task relating to said project and chosen from the following types: specifications, designs, codes, tests, and maintenance activities;
g. organizing hard and soft skills relating to ethical dimensions, cultural mediation, intellectual property safeguards, security and privacy safeguards, management and engineering practice, domain knowledge, and technology infrastructure of said computer software project;
h. overseeing the rollout of knowledge, skills, and behaviors for installing and operating the control points.

2. The process as in claim 1 further comprising the additional steps of:
i. evaluating entry criteria relating to outsource vendor profiles, customer needs, outsource vendor product, and intellectual property creation;
j. performing at least one of a group of tasks chosen from the following types: global outsource maturity assessment, outsource vendor selection, contracting, planning, requirements determination and management, change management, product acceptance, and innovation management;
k. performing product assurance;
l. evaluating exit criteria relating to the following categories: outsource vendor, project plan, requirements, changes, approved contract, funding, and cost return ratio.

3. A global enterprise process as in claim 2, wherein the global enterprise prepares and submits requirements and changes to requirements for said computer program software project to the global enterprise control point and issues a contract work order and contract work order changes to the global enterprise control point.

4. A global enterprise control point process as in claim 1, wherein the step (d) further comprising the steps of:
m. evaluating criteria relating to outsource vendor profiles, project plan, requirements, changes, approved contract, funding, and risks;
n. assessing issues relating to maturity, outsource vendor selection, process rollout, stakeholder training, change management, risk management, quality management, and culture mediation;
o. performing process assurance;
p. evaluating exit criteria relating to the following categories: outsource vendor profile, global outsource maturity assessment, approved offshore contract, offshore funding, trained stakeholders, project plan, requirements, and changes.

5. A global enterprise control point process as in claim 4, wherein the global enterprise control point receives requirements and changes to requirements for a computer program software project from a global enterprise, prepares and submits a project request and project request changes to the outsource vendor control point, receives a project request and project request changes acceptance from the outsource vendor control point, transmits said acceptance to a global enterprise, receives a contract work order and contract work order changes from a global enterprise, and transmits said contract work order and contract work order changes to the outsource vendor control point.

6. A global enterprise control point process as in claim 5, wherein the global enterprise control point exchanges necessary and essential multi-dimensional messages with the global enterprise and the outsource vendor control point.

7. A global enterprise control point process as in claim 5, wherein the global enterprise control point rolls out the necessary knowledge, skills,and behavior training of global enterprise staff and outsource vendor control point staff.

8. An outsource vendor control point process as in claim 1, wherein the step (e) further comprising the steps of:
q. evaluating criteria having to do with project plan, requirements, changes, approved contract, funding, risks, and completed outsource vendor product;
r. performing the tasks of outsource vendor profiling, outsource vendor selection; contracting, planning, requirements, change management, project tracking, risk management, and culture mediation;
s. assessing software quality;
t. evaluating exit criteria relating to the following categories: outsource vendor profiles, project plan, requirements, changes, approved outsource vendor contracts, funding, and cost return ratio.

9. An outsource vendor control point process as in claim 8, wherein the outsource vendor control point receives a computer program software project request and change request from the global enterprise control point, retrieves outsource vendor profiles for capable and available candidates to perform said computer program software project request, selects outsource vendor candidates to perform said computer program software project request, submits a task order request for proposal to said selected outsource vendor candidates, receives an outsource vendor acceptance of said computer program software project request, transmits said outsource vendor acceptance to the global enterprise control point, receives a contract work order and a contract work order change from the global enterprise control point, and transmits said contract work order and a contract work order change to the outsource vendor.

10. An outsource vendor control point process as in claim 9, wherein the outsource vendor control point exchanges necessary and essential multi-dimensional messages with the outsource vendor and the global enterprise control point.

11. An outsource vendor control point process as in claim 9, wherein the outsource vendor control point rolls out the necessary knowledge, skills, and behavior training of outsource vendor staff.

12. An outsource vendor process as in claim 1, wherein the step (f) of performing the out cotnry outsource vendor tasks associated with computer program software specification, design, code test, or maintenance further comprises the steps of:
u. evaluating entry criteria having to do with project plan, requirements, changes, approved contract funding and risks;
v. performing the tasks of outsource vendor profiling, software product engineering, change management, and innovation management;
w. conducting software inspection;
x. evaluating exit criteria relating to the following categories: outsource vendor profile, completed outsource vendor product; and intellectual property canonical form.

13. An outsource vendor process as in claim 12, wherein an outsource vendor submits an outsource vendor profile to the out source vendor control point; receives a task order and task order changes form the outsource vendor control point; transmits acceptance of said task order and task order changes; prepares for fulfillment through planning, staffing training and compliance with local custom; receives a contract work order and contract work order changes; performs the computer program software project; conducts software inspection on the computer program software project artifacts produced; and transmits required intellectual property in canonical form including state transitions and input/output semantics.

12. An outsource vendor process as in claim 1, wherein the step (f) of performing the out-country outsource vendor tasks associated with computer program software specification, design, code, test, or maintenance further comprises the steps of:
u. evaluating criteria having to do with project plan, requirements, changes, approved contract, funding, and risks;
v. performing the tasks of outsource vendor profiling, software product engineering, change management, and innovation management;
w. conducting software inspections;
x. evaluating exit criteria relating to the following categories: outsource vendor profile, completed outsource vendor product; and intellectual property canonical form.

13. An outsource vendor process as in claim 12, wherein an outsource vendor submits an outsource vendor profile to the outsource vendor control point; receives a task order and task order changes from the outsource vendor control point; transmits acceptance of said task order and task order changes; prepares for fulfillment through planning, staffing, training, and compliance with local custom; receives a contract work order and contract work order changes; performs the computer program software project; conducts software inspections on the computer program software project artifacts produced; and transmits required intellectual property in canonical form including state transitions and input/output semantics.
